(19) United States
(12) Patent Application Publication
(10) Pub. No.: US 2018/0022380 A1
(43) Pub. Date: Jan. 25, 2018

(54) HYDRAULIC ARRANGEMENT WITH TWO DRIVE MOTORS

(71) Applicant: Weber-Hydraulik GmbH, Guglingen (DE)

(72) Inventors: Ralf Naumann, Pfaffenhofen (DE); Torsten Winkler, Pfaffenhofen (DE)

(73) Assignee: Weber-Hydraulik GmbH, Guglingen (DE)

(21) Appl. No.: 15/654,203

(22) Filed: Jul. 19, 2017

(30) Foreign Application Priority Data
Jul. 20, 2016 (DE) 102016113366.3

(51) Int. Cl. B62D 5/06; B62D 3/14; B62D 5/30; B62D 5/065; B62D 5/04

(52) U.S. Cl. CPC B62D 5/064; B62D 5/065; B62D 5/046; B62D 5/0487; B62D 5/30; B62D 3/14

(57) ABSTRACT

A hydraulic drive arrangement (1) for the pressure supply of a hydraulic steering system (20), particularly for construction or agricultural machines, including a hydraulic pump (2) and an electric drive. It is essential that the electric drive is designed in a redundant fashion and has two separately controlled electric drive engines (3a, 3b), which are mechanically coupled via the hydraulic pump (2) in a rigid fashion, and that the separate control circuits (6a, 6b, 7a, 7b) are provided by which a variable load distribution can be specified for the electric drive engines (3a, 3b).

### INCORPORATION BY REFERENCE

The following documents are incorporated herein by reference as if fully set forth: German Patent Application No. 102016113366.3, filed Jul. 20, 2016.

### BACKGROUND

The present invention relates to a hydraulic drive arrangement for supplying pressure to a hydraulic steering system, particularly for utility vehicles, construction or agricultural machines, comprising a hydraulic pump and an electric drive.

Steering systems in motor vehicles today usually include hydraulic power steering systems. For this purpose, hydraulic power steering pumps are used in hydraulic steering systems for supplying power to support the steering motion.

These hydraulic power steering pumps are usually driven by the internal combustion engine of the motor vehicle. Over the course of increasing electrification of vehicles and measures for saving energy, e.g., start-stop functions, this objective is more and more assumed by electric motors. This way, increasingly higher currents are required for providing the necessary hydraulic output and both the demand as well as the load of the respective vehicle systems increases (such as on-board electric network and batteries) for supplying energy to the electric motors. This leads to an increased risk for malfunctions of the electrohydraulic steering systems.

With the solutions known from prior art on the one hand the mechanical capacity limits of motors are reached. Furthermore, the on-board electric networks for the power supply of a vehicle become more susceptible to malfunctions due to the rising currents required for supplying the hydraulic output demanded.

### SUMMARY

An objective of the invention is therefore to suggest a hydraulic drive arrangement with improved reliability and a compact design.

An obvious solution for improving the availability and reducing the risk of failure of hydraulic steering systems would be doubling the number of hydraulic drive arrangements and thus using two hydraulic arrangements.

In this solution it is however disadvantageous that on the one hand the structural space required is doubled and thus the installation is nearly impossible near the steering gear. Furthermore, here an expensive valve technology is required for adding the output of the hydraulic drive arrangements. These additional hydraulic functions further increase the risk of the hydraulic steering system failing.

According to the invention the above-mentioned objective is therefore attained in a hydraulic drive arrangement, a method, as well as a steering system having one or more features of the invention. Advantageous embodiments are discernible from the description and claims that follow. Hereby the wording of all claims is explicitly included in the description by way of reference.

The hydraulic drive arrangement according to the invention is preferably embodied by implementing the method according to the invention and/or a preferred embodiment thereof. The method according to the invention is preferably equipped for implementation via a hydraulic drive arrangement according to the invention and/or a preferred embodiment thereof.

The hydraulic drive arrangement according to the invention is embodied for supplying pressure to a hydraulic steering system, particularly for utility vehicles, construction or agricultural machines, and comprises a hydraulic pump and an electric drive.

It is essential that the electric drive is embodied redundantly and shows two separately controlled electric drive engines. The drive engines are coupled to each other in a mechanically rigid fashion via the hydraulic pump. The hydraulic pump is therefore driven by two separate drive engines.

For this purpose both drive engines each comprise a control circuit, which allows the joint operation of the drive engines with a variable load distribution for the two electric drive engines.

The control circuits may be integrated in the respective motor controllers allocated to the drive engines or embodied as separate components, i.e. as additional control circuits.

This results particularly in the advantages that by the redundant design with two drive engines the reliability of the hydraulic drive arrangement is increased, i.e. in other words the probability of the hydraulic drive arrangement failing is reduced. Furthermore, by the two drive engines the hydraulic output can be increased. In spite thereof, the hydraulic drive arrangement requires only a comparatively small structural space and this way it can easily be positioned near the steering gear.

By the design as a hydraulic pump with two independent drive engines the use of expensive valve technology can be avoided. The additional valve technology and/or other structural components, which would be required for adding the two hydraulic outputs when using two hydraulic pumps, can advantageously be waived by the invention. This reduces the susceptibility to malfunctions of the hydraulic drive arrangement and also reduces the overall structural space required for the system.

An assembly is known from DE 10 207 018 A1 with a hydraulic pump, which is integrated in an electric motor and thus is arranged between two half-motors. In this assembly it is disadvantageous that a common control of the two half-motors occurs and thus the above-mentioned advantages according to the invention are not attained.

In a preferred embodiment according to the invention one motor controller is provided for each of the electric drive engines. The motor controllers are preferably embodied for controlling the electric drive engines.

Preferably the motor controllers are each embodied with a motor control and control logic in the form of a control circuit. This way, a processor is provided in the form of control logic as a part of the motor controller, which can also be used for calculations or control functions of the steering system. In this embodiment the control circuits are integrated in the electric drive engines as parts of the motor controller.

In an alternative embodiment of the invention the motor controllers are embodied only with a single motor control each. In this case, at least two additional control circuits are provided in order to control the joint operation of the drive engines with a variable load distribution for the two electric drive engines.

In a preferred embodiment of the invention the hydraulic pump is embodied as a gear pump. A gear pump usually comprises a cooperating pair of sprockets. The two drive engines preferably engage at least one of the sprockets of the pump. Preferably the pump is equipped with a drive at both sides. Here, the two drive engines may each be allocated to the same pump shaft. By this arrangement a compact and space-saving embodiment of the hydraulic drive arrangement can be achieved in a simple fashion.

Preferably the hydraulic pump is arranged between the two drive engines. It is particularly preferred to mechanically couple the two drive engines via a common shaft of the hydraulic pump.

Alternatively, the two drive engines can engage two pump shafts, particularly preferred one drive engine engages one sprocket of the hydraulic pump and the other drive engine the other sprocket of the hydraulic pump. The mechanical coupling occurs in this case via the sprockets of the gear pump.

In a preferred embodiment of the invention the drive engines are embodied as brushless electric motors. These motors are typically resilient with regards to wear and tear and show comparatively long life spans. The drive engines, as commonly known, each comprise a rotor and a stator as well as respectively a motor controller. Via the respective motor controller the speed control of the drive engines occurs. In order to specify the variable load distribution to the electric drive engines the two control circuits issue control commands to the drive engines. Here, the control circuits stipulate the speed and the maximally permitted power input for each drive engine. Commonly the software of a typical motor controller provides that the speed is kept consistent to the specification until the maximum power is reached. Thereafter only the maximally permitted speed is adjusted/reached, which can be achieved with the maximum current. Preferably, by the respective motor controller a control for limiting the maximum power is superimposed to each individual drive engine.

This can occur both via the control logic as a part of the power electronic of the motor controller or via an additional control circuit for controlling the drive engines.

In order to obtain feedback regarding the status of the rotors of the two drive engines, preferably a rotary angle encoder is arranged at least at one of the drive engines, preferably at both drive engines. Via the rotary angle encoder the rotary angle of the rotor can be determined in order to ensure optimal cooperation of the two drive engines. Preferably the two drive engines run synchronously. The speed control of the two engines is preferably optimized such that in spite of mechanical coupling the effectiveness of the individual engines is not negatively influenced. This occurs preferably via the control architecture of the drive engines. The control architecture of both drive engines is designed such that by way of parameterizing the controls they can be adjusted such that any disturbances briefly developing by the coupling of the engines are permitted within deviation limits, however continued deviations of the speed are compensated.

In an advantageous further development of the invention the control circuits for the variable load distribution are embodied such that by utilizing information regarding the operating state of the drive engines and the condition of the energy supply they for example calculate the optimal energy distribution with regards to the life span of the components and provide the speed and maximum power specifications respectively allocated to the motor controllers.

In a preferred embodiment of the invention the two drive engines are controlled such that the power of each of the two drive engines amounts respectively to half the power to be provided in total. This results in the advantage that the power provided overall can be controlled in a targeted fashion.

In an alternative embodiment the two drive engines are addressed such that one of the two drive engines is operated up to maximum power and if necessary, preferably via the central master control circuit, any power to be provided additionally is requested from the second drive engine.

This embodiment is particularly suited for an embodiment in which both drive engines show different, independent power supplies. If for example one of the two drive engines is operated with a power supply from a preferred energy source, the maximum power can be requested from this engine. Similarly, in a situation in which for example one of the two drive engines is operated with the power supply from a battery with a lower charge level, only the power difference can be requested from this drive engine. Additionally, the respectively given power supply situation can be reacted to in an advantageous fashion.

In particular, the control circuits are embodied such that they mutually monitor for malfunctions. Here, preferably the mutual control occurs of plausibility of the commands of all control circuits.

Preferably, in case of a detected malfunction by the control circuits not affected by said malfunction the power of the corresponding electric drive engine can be adjusted, particularly increased.

This results in the advantage that in case of a malfunction the tasks of the control circuit can either be assumed by the control circuit not affected by the malfunction. Alternatively, the control circuit not affected by the malfunction can operate the remaining drive engine with a higher output in order to compensate the malfunction. This way the risk for the steering system failing is further reduced.

In a preferred embodiment of the invention it is provided that the control circuits are embodied such that one of the control circuits operates as a master control circuit, which master control circuit specifies a load distribution for the electric drive engines. Preferably the other control circuit operates as a slave control circuit, with the master control circuit specifying to the slave control circuit a drive output for the electric drive engine controlled by the slave control circuit.

The load distribution is preferably controlled by the master control circuit via a respectively specified speed. Here, a variable load distribution occurs preferably such that the joint effectiveness of the two drive engines is essentially equivalent to the effectiveness of the individual drive engines, i.e. that in spite of the mechanical coupling of the engines no loss in output occurs.

In a preferred embodiment of the invention the hydraulic drive arrangement comprises a third control circuit, with this third control circuit operating as a master control circuit, and/or being embodied to operate as a master control circuit. Here, the third control circuit addresses as the master control circuit both control circuits of the two drive engines as slave control circuits centrally with the variable load distribution.

In particular by the use of three control circuits secure operation can be ensured. In case of a failure or a malfunction of one control circuit the remaining two control circuits can still implement the full functionality and the steering system can therefore be operated until the vehicle comes to a halt.

Preferably, the third control circuit is also embodied redundantly, so that three additional external control circuits, i.e. preferably a total of four control circuits, are provided. In this case the engine controllers may be equipped with monitoring and/or plausibility functions only.

The above-described objective is further attained by the method.

The method according to the invention for operating a hydraulic drive arrangement for the pressure supply of a hydraulic steering system is preferably implemented with a hydraulic drive arrangement comprising a hydraulic pump and an electric drive.

It is essential that the electric drive comprises two separately controlled electric drive engines with at least two separate control circuits. A variable load distribution to the electric drive engines is achieved via the separate control circuits.

The method according to the invention also shows the above-mentioned advantages of the hydraulic drive arrangement according to the invention.

In an advantageous further development the variable load distribution to the electric drive engines occurs such that, utilizing the information regarding the operating state of the drive engines and the status of the energy supply, they calculate for example the optimal energy distribution with regards to life span and condition of the components, and provide the speed and maximum power specifications to the respectively allocated motor controllers.

Preferably the variable load distribution occurs such that the joint effectiveness of the two drive engines is essentially equivalent to the effectiveness of the individual drive engines.

This type of control is particularly advantageous for the use of a common power supply of the two drive engines. Both engines are equally stressed electrically, mechanically, and thermally. As a result, the output provided is here dependent on the joint stress of the two drive engines.

Preferably the two drive engines are each operated in a speed-controlled fashion according to the variable speeds specified.

Alternatively, here the control can occur such that the output of each of the two drive engines amounts respectively to half of the output to be provided overall. This allows a targeted influencing of the power provided overall.

In another alternative embodiment the variable load distribution can occur such that one of the two drive engines is operated with its maximum output. The output difference to the output to be provided overall is then requested from the second drive engine. This type of control is particularly suited when the two drive engines show different power supplies, which are independent from each other. Then for example a differentiation is possible depending on the type of energy source. For example, based on the charge status of a battery, here the battery with the lower charge stating can be released for example by operating the corresponding drive engine with a reduced power. Alternatively, the drive engine can be operated using a preferred energy source with the stronger power.

The above-described objective is attained furthermore with a steering system comprising a hydraulic drive arrangement according to the invention. Here the hydraulic drive arrangement according to the invention is suitable for the use in a front axle or rear axle steering system.

In a preferred further development of the invention the hydraulic drive arrangement is controlled via a communication network, preferably a bus-system. Here, communication of the control circuits with each other is possible via the communication network. The communication network preferably connects the two control circuits to each other. If additional other control circuits are provided, for example as master control circuits, the communication network preferably connects the additional control circuits with the two control circuits of the drive engines. The communication network preferably is a part of the steering system.

Preferably, the communication to a power supply for the two drive engines occurs via the communication network as well. For this purpose preferably a central control of the power supply is provided. In order to reduce the risk for failures of the voltage supply it is preferably also embodied in a redundant fashion. The voltage supply is preferably a part of the steering system. Additionally, a device (battery surveillance) is optionally provided for monitoring the charge status of the batteries of the voltage supply (charge status monitoring), preferably with an additional function for compensating the charge levels (balancer function).

The hydraulic drive arrangements according to the invention are particularly suitable for the realization of a displacement control for operating electrohydraulic steering systems and allow here an increase of the availability and a reduction of the probability of failures.

### BRIEF DESCRIPTION OF THE DRAWINGS

Additional preferred features and exemplary embodiments of the hydraulic drive arrangement according to the invention as well as the device according to the invention and the steering system according to the invention are explained hereinafter based on an exemplary embodiment and the figures. Shown are:

FIG. 1 a schematic illustration of a first exemplary embodiment of a hydraulic drive arrangement according to the invention comprising a steering system;

FIGS. 2A and 2B schematic illustrations of a second exemplary embodiment of a hydraulic drive arrangement according to the invention with two variants in the image details;

FIG. 3 a schematic illustration of a third exemplary embodiment of a hydraulic drive arrangement according to the invention;

FIG. 4 a schematic illustration of an exemplary embodiment of a steering system according to the invention.

### DETAILED DESCRIPTION OF THE PREFERRED EMBODIMENTS

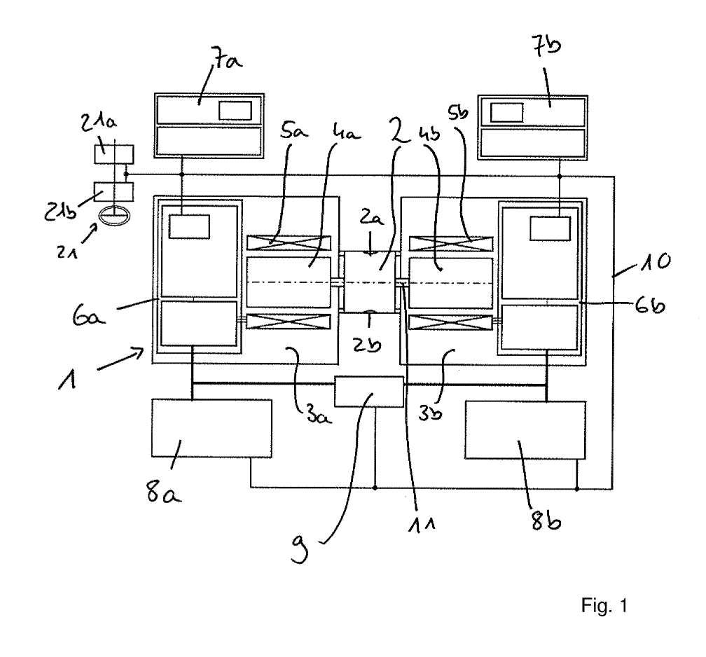

In FIGS. 1 to 4, identical reference characters indicate identical elements or elements with the same effect.

FIG. 1 shows a schematic illustration of a first exemplary embodiment of a hydraulic drive arrangement according to the invention.

The hydraulic drive arrangement 1 comprises a hydraulic pump 2 and two drive engines 3a, 3b. The drive engines 3a, 3b are each embodied with a rotor 4a, 4b and a stator 5a, 5b and each comprise a motor controller 6a, 6b.

In the present case the two drive engines 3a, 3b are embodied as brushless electric engines.

In a redundant embodiment in the present case additionally a control circuit 7a, 7b is provided for each of the two drive engines.

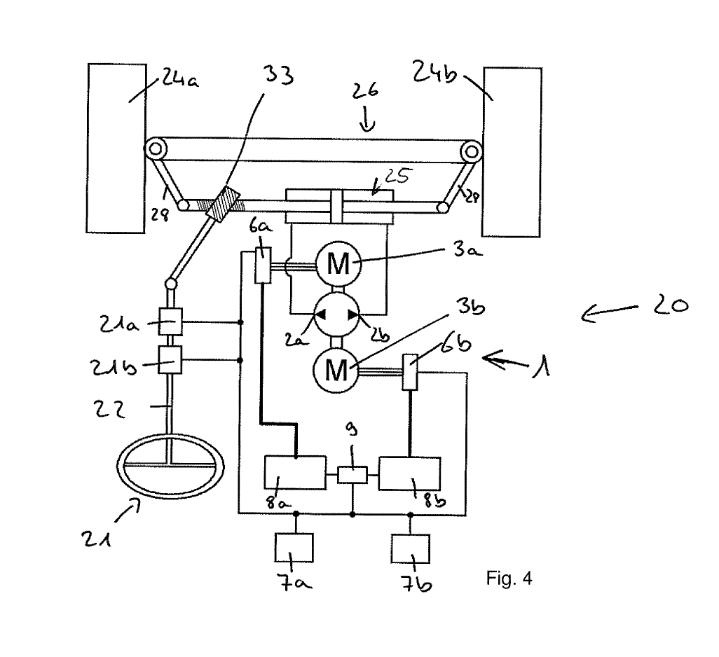

The hydraulic pump 2 is embodied as a gear pump with a drive at both sides. Via the two connections 2a, 2b the hydraulic liquid is fed to the hydraulic cylinder 25, shown in FIG. 4. The hydraulic pump 2 is arranged between the two drive engines 3a, 3b.

The hydraulic drive arrangement with the two drive engines 3a, 3b is supplied with two power supplies 8a, 8b for the two drive engines 2, 3. Additionally, a device (battery surveillance) 9 is provided to monitor the charge status of the batteries of the voltage supplies (charge status monitoring), in the present case provided with the additional function to compensate the charge conditions (balancer function).

A communication network 10, which in the present case is embodied as a bus-system, connects the two control circuits 7a, 7b to the two motor controllers 6a, 6b of the drive engines 3a, 3b and the two power supplies 8a, 8b and the charge status monitoring 9.

Additionally, a steering wheel 21 is shown schematically comprising sensors 21a, 21b for detecting the steering angle of the steering wheel 21 and the torque applied to the steering wheel. Common sensors can be used as the sensors 21a, 21b for the steering systems. The sensors 21a, 21b are integrated in the communication network 10. Here, the sensors, particularly those known for steering systems, are embodied in a redundant fashion and/or at least the signals are redundant and provided by the sensors, already checked for plausibility.

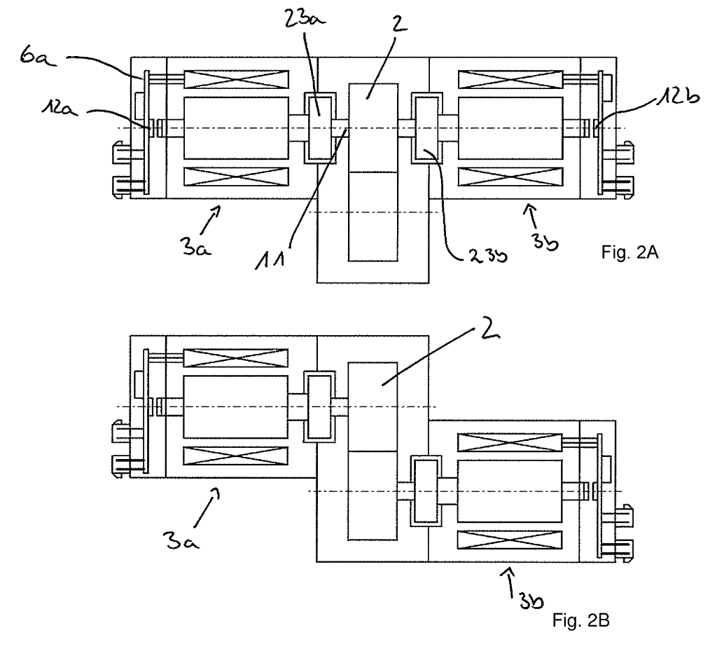

The two drive engines are mechanically coupled rigidly to each other via the hydraulic pump 2. For this purpose the two drive engines 3a, 3b are arranged in the present case on a common shaft 11 with the hydraulic pump 1. They are connected via shaft couplings 23a and 23b to a common shaft 11 and thus to the hydraulic pump 2, as shown in FIGS. 2A and 2B.

Alternatively the drive of the pump can directly occur via one of the shafts of the drive engines.

The electric drive of the hydraulic drive arrangement is designed redundantly via the two drive engines 3a, 3b. The two drive engines 3a, 3b can each be controlled via the corresponding control circuit 7a, 7b. For this purpose the two control circuits 7a, 7b issue control commands to the motor controllers 6a, 6b of the drive engines 3a, 3b. The power electronic for the control of the drive engines 2, 3 is located in the motor controllers 6a, 6b. The control circuits 7a, 7b assume redundantly the processing of the control signals (speed, maximum current) depending on the steering requirements detected by the sensors 21a and 21b.

A variable load distribution to the electric drive engines occurs via the two control circuits 7a, 7b in order to achieve the specified output of the hydraulic drive arrangement. The two drive engines 3a, 3b can each be controlled via the respectively allocated control circuit 7a, 7b. Alternatively the two drive engines can be controlled by the respectively other control circuit. It is also possible that both drive engines are controlled by one of the control circuits 7a, 7b.

Here, the control circuits specify the speed and the maximally permitted power input by each drive engine. In order to determine these parameters the control circuits detect the operating status of the drive engines and the status of the energy supply, and then calculate the optimal energy distribution with respect to the power demands according to life span and condition of the components (drive engines, power supply). This is then transferred in the form of a specified speed and maximum power to the motor controllers respectively allocated.

In the present case the control circuit 7a operates as the master control circuit. The control circuit 7b is embodied such that it operates as a slave control circuit and monitors and/or checks the specifications of the master control circuit 7a for plausibility. In order to reach the drive output specified by the two control circuits 7a, 7b the engine controllers 6a, 6b control the drive engines 3a, 3b.

In case of a failure or a malfunction of one of the two drive engines 3a, 3b the drive engine not affected by the failure or malfunction assumes the provision of the required hydraulic output up to its maximum capacity. The control occurs via the control circuits 7a, 7b, which in case of a failure of one of the two drive engines 3a, 3b increase the power demand (in the form of specified speed and maximum current) to the remaining drive engine.

In case of a failure or a malfunction of one of the two control circuits 7a, 7b the control circuit not affected by the failure or the malfunction assumes the control of the two drive engines 3a, 3b. This reliability is therefore activated both in case of a malfunction of one of the two controls as well as a malfunction of one of the two drive engines.

In case of a steering motion (commonly a rotation of the steering wheel 21) the sensors 21a, 21b detect the steering angle and the torque of the steering wheel 21. This information is forwarded by the communication network 10 to the control circuit 7a as the master control circuit. The control circuit 7a then issues appropriate control commands to the engine controllers 6a and 6b. The control circuit 7b performs a plausibility check of the control commands of the control circuit 7a.

In order to reach the drive output specified by the master control circuit 7a the engine controllers 6a, 6b adjust the drive engines 3a, 3b to the specified speed in consideration of the respectively specified maximum current.

In case of a malfunction or a failure of one of the two control circuits 7a, 7b or the drive engine 3a, 3b the tasks of one control circuit 7a, 7b or one of the drive engines 3a, 3b are assumed by the control circuit 7a, 7b not affected or the drive engine 3a, 3b not affected by the malfunction. For example, the control circuit 7a, 7b not affected by the malfunction can operate the remaining drive engine 3a, 3b with a higher output in order to compensate the malfunction.

By the redundant design with the two drive engines 3a, 3b the failure rate of the hydraulic drive arrangement is reduced. In spite thereof, the hydraulic drive arrangement only requires a relatively small structural space and this way can easily be positioned near the steering gear.

In order to avoid unnecessary repetitions hereinafter only the differences between the figures will be discussed.

FIGS. 2A and 2B show schematic illustrations of two variants for the arrangement of the two drive engines 3a, 3b in reference to each other and/or the hydraulic pump 2.

FIG. 2A shows a first variant of the arrangement of the drive engines 3a, 3b. The hydraulic pump 2 is arranged between the two drive engines 3a, 3b. Here, the two drive engines 3a, 3b and the hydraulic pump 2 are arranged on a common shaft 11 and mechanically coupled in a rigid fashion. For this purpose the two drive engines 3a, 3b are connected via shaft couplings 23a and 23b to a common shaft 11 and this way to the hydraulic pump 2.

FIG. 2B shows a second variant of the arrangements of the drive engines 3a, 3b. The hydraulic pump 2 is also arranged here between the drive engines 3a, 3b. In the present case, however, the drive engine 3a is coupled to a first pump sprocket of the hydraulic pump. The dive engine 3b is however coupled to a second sprocket of the hydraulic pump. The two drive engines 3a, 3b are therefore not arranged on a common shaft. The coupling occurs via the sprockets of the hydraulic pump 2.

Depending on the structural space available in which the hydraulic drive arrangement shall be placed one of the two above-described variants can be selected.

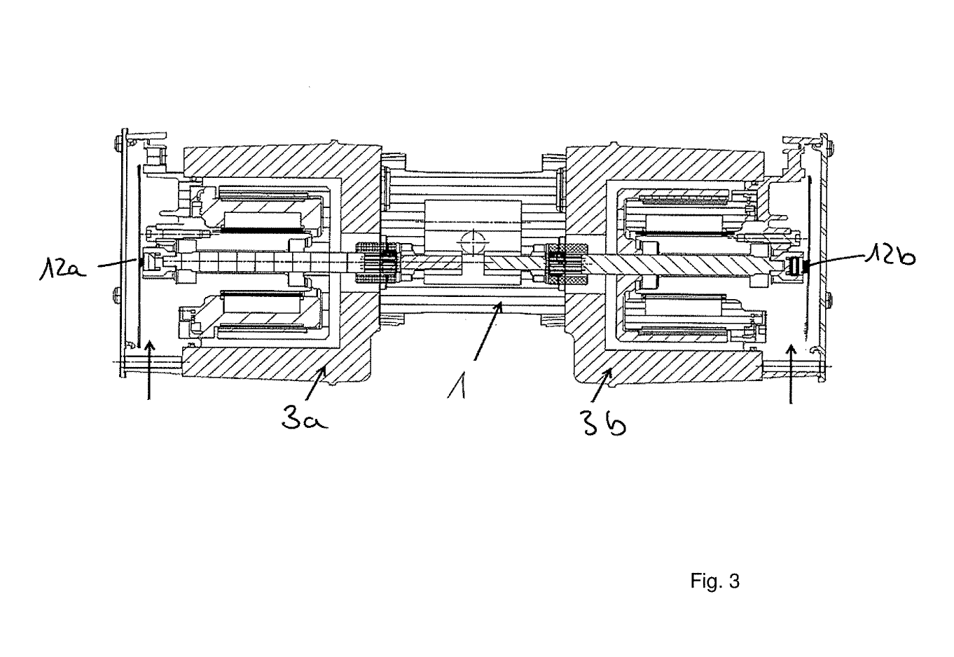

FIG. 3 shows a schematic illustration of a detail of a hydraulic drive arrangement according to the invention.

The two drive engines 3a, 3b are arranged with the hydraulic pump 2 on a common shaft. The hydraulic pump 2 is arranged between the two drive engines 3a, 3b. One rotary angle encoder 12a, 12b each is arranged at the drive engines 3a, 3b.

The respective status of the rotor can be determined via the rotary angle encoder 12a, 12b. This allows to control optimal cooperation of the two drive engines. In order to achieve maximum hydraulic output the two drive engines operate in a synchronized fashion. The control architecture of both drive engines 3a, 3b is here designed such that via parameterizing an adjustment of the controllers to the different operating conditions is possible and they can be adjusted such that even errors developing by the coupling of the drive engines 3a, 3b can be compensated.

FIG. 4 shows a schematic illustration of a first exemplary embodiment of a steering system 21 according to the invention. The steering system 21 is in the present case controlled by displacement, as known from prior art. The steering system 21 comprises a steering wheel 20, a steering column 22, sensors 21a, 21b for detecting the steering angle of the steering wheel 21, a hydraulic drive arrangement 1, a mechanical steering gear 33, and a steering cylinder 25 for providing steering power in an effective connection to the hydraulic drive arrangement 1.

The steering gear 33 and the steering cylinder 25 are arranged cooperating at the tie rod 28 in connection with the drop arms 27 and the front axle 26.

The hydraulic drive arrangement 1 is embodied in the present case as a hydraulic drive arrangement 1 according to the invention with two drive engines 3a, 3b and one hydraulic pump 2. Via the two connections 2a, 2b the hydraulic liquid is fed to the hydraulic cylinder 25. The hydraulic drive arrangement 1 is embodied as described in FIGS. 1 and 3.

During a steering motion the rotary motion of the steering wheel 21 is detected by the sensors 21a, 21b and transferred via the steering column 22 to the mechanical steering gear 33. The information of the sensors 21a, 21b is transferred via the communication network 10 to the control circuit 7a, 7b of the hydraulic drive arrangement 1.

The hydraulic drive arrangement 1 operates as described for FIG. 1. Here, support of the steering force occurs by the hydraulic drive arrangement via the steering cylinder 25, acting via the drop arms 27 and the front axle 26 upon the wheels 24a, 24b.

1. A hydraulic drive arrangement (1) for pressure supply of a hydraulic steering system, comprising a hydraulic pump (2), a redundant electric drive that comprises two separately controlled electric drive engines (3a, 3b) that are mechanically coupled to each other via the hydraulic pump (2) in a rigid fashion, and separate control circuits (6a, 6b, 7a, 7b) by which a variable load distribution over the electric drive engines (3a, 3b) is specified.

2. The hydraulic drive arrangement (1) according to claim 1, wherein the electric drive engines (3a, 3b) each comprise motor controllers (6a, 6b) that are embodied to control the electric drive engines (3a, 3b).

3. The hydraulic drive arrangement (1) according to claim 2, wherein the control circuits (7a, 7b) are each integrated in the motor controllers (6a, 6b), and the motor controllers (6a, 6b) each are formed with a motor control and a control logic acting as the control circuit (7a, 7b).

4. The hydraulic drive arrangement (1) according to claim 1, wherein the control circuits (6a, 6b, 7a, 7b) are embodied to monitor each other for malfunctions.

5. The hydraulic drive arrangement (1) according to claim 4, wherein in case of a detected malfunction the control circuit (6a, 6b, 7a, 7b) not affected by the malfunction is configured to adjust an output of an associated one of the electric drive engines (3a, 3b).

6. The hydraulic drive arrangement (1) according to claim 1, wherein the control circuits (6a, 6b, 7a, 7b) are embodied such that one of the control circuits (6a, 6b, 7a, 7b) operates as a master control circuit, which specifies a load distribution for the electric drive engines (3a, 3b) and specifies to the other control circuit (6a, 6b, 7a, 7b) operating as a slave control circuit an operating output for the electric drive engine (3a, 3b) controlled thereby.

7. The hydraulic drive arrangement (1) according to claim 6, wherein the control circuits (6a, 6b, 7a, 7b) are embodied to coordinate a master and slave allocation in reference to each other.

8. The hydraulic drive arrangement (1) according to claim 1, further comprising an additional control circuit as a master control circuit that controls the electric drive engines (3a, 3b) via the respective motor controller (6a, 6b).

9. The hydraulic drive arrangement (1) according claim 1, further comprising a communication network (11) for the communication between the control circuits (6a, 6b, 7a, 7b) with each other.

10. The hydraulic drive arrangement (1) according to claim 1, wherein the hydraulic pump (2) is embodied as a gear pump

11. The hydraulic drive arrangement (1) according to claim 10, wherein the gear pump has a drive at both sides.

12. The hydraulic drive arrangement (1) according to claim 1, wherein the two drive engines (3a, 3b) are mechanically coupled via a common shaft.

13. The hydraulic drive arrangement (1) according to claim 12, wherein the two drive engines (3a, 3b) and the hydraulic pump (2) are arranged on a common shaft (11), and the hydraulic pump (2) is arranged between the two drive engines (3a, 3b).

14. The hydraulic drive arrangement (1) according to claim 1, wherein the two drive engines (3a, 3b) are mechanically coupled via the hydraulic pump (2).

15. The hydraulic drive arrangement (1) according to claim 14, wherein the two drive engines (3a, 3b) are mechanically coupled via the pump gears of the hydraulic pump (2), and a rotor (4a, 4b) of the two drive engines (3a, 3b) is arranged on a common shaft (11) with at least one pump gear of the hydraulic pump (2).

16. The hydraulic drive arrangement (1) according to claim 1, wherein the two drive engines (3a, 3b) are embodied as brushless electric engines, and a rotary encoder (12a, 12b) is provided at least at one of the two drive engines (3a, 3b).

17. The hydraulic drive arrangement (1) according to claim 1, wherein common motor cooling for the two drive engines (3a, 3b) is provided via a hydraulic fluid of the hydraulic pump (2).

18. The hydraulic drive arrangement (1) according to claim 1, wherein the hydraulic drive arrangement (1) is embodied for a front axle and/or a rear axle steering system.

19. A method for operating a hydraulic drive arrangement (1) for pressure supply to a hydraulic steering system (20) with a hydraulic pump (2) and an electric drive, wherein the electric drive comprises two separately controlled electric drive engines (3a, 3b) with separate control circuits (6a, 6b, 7a, 7b) and the method comprises driving the separately controlled drive engines via the control circuits (6a, 6b, 7a, 7b) and providing a variable load distribution to the electric drive engines (3a, 3b).

20. A steering system (20) comprising a hydraulic drive arrangement (1) according to claim 1.
